(19) United States
(12) Patent Application Publication
(10) Pub. No.: US 2026/0273722 A1
(43) Pub. Date: Sep. 17, 2026

(54) REMOVABLE TOOL DRAWER SYSTEM

(71) Applicant: Great Neck Saw Manufacturers, Inc., Memphis, TN (US)

(72) Inventor: Jeffrey G. Karl, Rossville, TN (US)

(73) Assignee: Great Neck Saw Manufacturers, Inc., Memphis, TN (US)

(21) Appl. No.: 19/565,245

(22) Filed: Mar. 12, 2026

Related U.S. Application Data
(60) Provisional application No. 63/770,905, filed on Mar. 12, 2025.

(51) Int. Cl. B25H 3/06; B25H 1/04; B25H 3/02

(52) U.S. Cl. CPC B25H 3/06; B25H 1/04; B25H 3/02

(57) ABSTRACT

A removable drawer system can include a toolbox comprising a plurality of removable drawers. At least one removable drawer may include a first coupling structure defined at an underside. The removable drawer system can further include a rolling tool tray comprising a plate defining a second coupling structure configured to releasably couple with the first coupling structure of the at least one removable drawer. The rolling tool tray can further include a latching mechanism configured to releasably couple with a latch component of the at least one removable drawer, and a lifting mechanism configured to adjust a vertical height of the plate.

### CROSS-REFERENCES TO RELATED APPLICATIONS

The present application claims priority on U.S. Provisional Application No. 63/770,905 filed on Mar. 12, 2025, entitled “Removable Tool Drawer System,” the entire disclosure of which is incorporated by reference herein.

### BACKGROUND

Large toolboxes can be used store supplies and tools for mechanical repairs. Rolling toolboxes may be large (e.g., seven feet wide and seven feet tall) and can retain various unrelated tools and parts. In certain environments (e.g., automotive, etc.) a rolling tool tray may be used to unload and transport supplies from the toolbox to a secondary location (e.g., near an automobile needing repairs).

### SUMMARY

Aspects of the present disclosure describe a removable drawer system having a toolbox comprising removable drawers configured to mount to a rolling tool tray. One general aspect includes a removable drawer system. The removable drawer system can include a toolbox comprising a plurality of removable drawers. At least one removable drawer may comprise a first coupling structure defined at an underside. The removable drawer system may further include a rolling tool tray. The rolling tool tray may include a plate defining a second coupling structure configured to releasably couple with the first coupling structure of the at least one removable drawer; a latching mechanism configured to releasably couple with a latch component of the at least one removable drawer; and a lifting mechanism configured to adjust a vertical height of the plate.

In some examples, the first and second coupling structures may have a complementary shape.

In some examples, the plate may include at least one dovetail component, and wherein the first coupling structure comprises at least one reciprocal dovetail component.

In some examples, the first coupling structure can include a plurality of engagement faces oriented inward, and the second coupling structure can include a plurality of engagement faces oriented outward.

In some examples, the first coupling structure may include a first plurality of engagement faces. The second coupling structure may include a second plurality of engagement faces. The first plurality of engagement faces may be configured to engage with the second plurality of engagement faces based on physical contact between the first and the second plurality of engagement faces. The physical contact may restrain movement of the at least one removable drawer with respect to the plate of the rolling tool tray.

In some examples, the at least one removable drawer and the rolling tool tray are configured to be in a coupled state when the first coupling structure is engaged with the second coupling structure and the latching mechanism is releasably coupled with a notch of the at least one removable drawer.

In some examples, the latching mechanism is configured to secure the at least one removable drawer to the plate in a direction that is different than a plurality of directions in which the first coupling structure and the second coupling structure restrain movement of the at least one removable drawer with respect to the plate.

In some examples, the second coupling structure and the latching mechanism are configured to secure the at least one removable drawer to the rolling tool tray across all degrees of freedom.

In some examples, the first coupling structure and the second coupling structure are configured to restrain movement between the at least one removable drawer and the rolling tool tray in at least a first direction and a second direction. The latching mechanism can be configured to restrain movement in a third direction, wherein the third direction is different than the first and second directions.

In some examples, the at least one removable drawer is moveably housed in a slot of the toolbox via a set of drawer slides. The set of drawer slides may include a hard stop configured to secure the at least one removable drawer in the slot.

In some examples, the at least one removable drawer is configured to be removed from the slot by lifting the at least one removable drawer over the hard stop.

In some examples, the lifting mechanism is a hydraulic lift, and wherein the hydraulic lift is activated in response to pressure applied to a foot pedal.

In some examples, the removable drawer system further includes a racking system configured to house the at least one removable drawer.

Another general aspect includes a rolling support platform. The rolling support platform can include a frame, a lifting mechanism connected to the frame, a plurality of wheels connected to the frame to enable rolling movement, and a plate connected to the lifting mechanism. A coupling structure may be defined at the plate and configured to releasably couple with a corresponding coupling structure of a removable container. The lifting mechanism may be configured to adjust a vertical height of the plate.

In some examples, the rolling support platform can further include a rotating platform disposed between the plate and the lifting mechanism. The rotating platform may be configured to rotate the plate with respect to the frame.

In some examples, the coupling structure can include a trapezoidal planar surface defined by a pair of parallel sides and a pair of nonparallel sides. A leading parallel side of the pair of parallel sides may be shorter in length than a trailing parallel side of the pair parallel sides. The coupling structure may further include a set of angled surfaces extending from the trapezoidal planar surface. Each angled surface of the set of angled surfaces may form an angle with respect to the trapezoidal planar surface. The set of angled surfaces may include a first angled surface extending from the trapezoidal planar surface at the leading parallel side. The first angled surface may extend in a first direction away from a center of the trapezoidal planar surface. The set of angled surfaces may further include second angled surface extending from the trapezoidal planar surface at a first nonparallel side of the pair of nonparallel sides. The second angled surface may extend in a second direction away from the center of the trapezoidal planar surface. The set of angled surfaces may further include a third angled surface extending from the trapezoidal planar surface at a second nonparallel side of the pair of nonparallel sides. The third angled surface may extend in a third direction away from the center of the trapezoidal planar surface.

In some examples, the coupling structure is configured to releasably couple with the corresponding coupling structure of the removable container via insertion of the plate into the corresponding coupling structure such that the leading parallel side leads the insertion.

In some examples, each angled surface of the set of angled surfaces extends at the same angle with respect to the trapezoidal planar surface.

Another general aspect includes a toolbox. The toolbox can include a plurality of removable drawers. At least one removable drawer of the plurality of removable drawers may include a coupling structure and a notch defined at an underside of the at least one removable drawer. The coupling structure may be configured to releasably couple with a corresponding coupling structure of a support platform, and the notch may be configured to physically engage with a latching mechanism of the support platform to restrain movement of the at least one removable drawer with respect to the support platform when the at least one removable drawer is coupled with the support platform.

In some examples, the coupling structure can include a plurality of engagement faces, and each engagement face of the plurality of engagement faces may be oriented at an angle facing a center of the coupling structure.

### BRIEF DESCRIPTION OF THE DRAWINGS

FIG. 1 is an isometric view of a removable drawer system that includes a rolling tool tray and a toolbox, in accordance with various embodiments.

FIG. 2 depicts an isometric view of a removable drawer system including a rolling tool tray attached to a removable drawer of a toolbox, in accordance with various embodiments.

FIG. 3 depicts an isometric view of a removable drawer system including a removable drawer of a toolbox being mounted to a rolling tray and removed from a toolbox, in accordance with various embodiments.

FIG. 4 depicts an exploded view of a rolling tool tray, in accordance with various embodiments.

FIG. 5 depicts a plan view of a removable drawer, in accordance with various embodiments.

FIGS. 6A-6B depict plan views of a receiving structure of a removable drawer engaging with a plate of a rolling tool tray, in accordance with various embodiments.

FIG. 7 depicts an exploded view of various components of a removable drawer and a rolling tool tray, in accordance with various embodiments.

FIGS. 8A-8C depict a side view of a latching mechanism for securing a rolling tray to a removable drawer, in accordance with various embodiments.

FIG. 9 illustrates an example racking system, in accordance with various embodiments.

FIGS. 10A-10B show an alternative example of a removable drawer system, in accordance with various embodiments.

FIG. 11 depicts an alternative example of a rolling tool tray with a foot pedal, in accordance with various embodiments.

FIG. 12 illustrates an alternative depiction of a rolling tool tray with a lifting mechanism, in accordance with various embodiments.

FIG. 13 illustrates an alternative example of a rolling toolbox, in accordance with various embodiments.

FIG. 14 illustrates an example method, in accordance with various embodiments.

### DETAILED DESCRIPTION

A conventional rolling toolbox may include modular components to separate various tools and/or repair parts. In some environments, mechanics may use a rolling tool tray to load materials from the toolbox and transport the materials to a repair site (e.g., to a car). However, conventional rolling tool trays and toolbox systems may be inefficient for mechanics to transport materials. As described herein, a modular component (e.g., drawer, shelf, etc.) of a toolbox may retain various parts and/or tools. Loading and unloading a tool tray to move parts and/or tools to a repair site can increase time associated with a repair. Further, some parts and tools may be associated with specific jobs, repairs, car types, etc. A mechanic may search for correct supplies and differentiate between sets of tools or parts to prepare for a repair job, which can increase job times. Increased time due to searching for tools can increase costs associated with a repair and can reduce the number of repairs a mechanic may be able to complete within an allotted time. Moreover, toolboxes can often include and store items and drawers that may be of varying sizes and weights, which can make securely mounting a drawer to a tool tray difficult, particularly when the tool tray lacks a specific or designated structure to enable secure placement or mounting of modular storage units.

The examples described herein relate to removable drawer systems and methods for constructing and operating such removable drawer systems. Examples of the removable drawer systems described herein may include a rolling tool tray configured to releasably couple with a removable drawer of a toolbox. The rolling tool tray may include a plate that defines a coupling structure that is configured to releasably couple with a coupling structure defined by a receiving structure of a removable drawer. Releasably coupling the rolling tool tray to the removable drawer may enable a removable drawer of the drawer system to securely mount onto the rolling tool tray and enable a user to move the rolling tray including the drawer to a secondary location. The rolling tray can include a lifting mechanism configured to adjust a vertical height of the tool tray to match a height of a drawer of the system. A toolbox may include one or more drawers (e.g., shelves) that include preset materials, such as tools for a specific repair (e.g., oil and lube jobs, brake jobs, etc.), tools for a specific type of vehicle (e.g., GMC, Volvo, Honda, etc.), and/or tools organized in any other suitable manner (e.g., tools belonging to a particular user, etc.). In some examples, the rolling tray may releasably couple with a racking system and enable a user to move a tray (e.g., a parts tray for car repair parts) into and/or out of the racking system.

While the embodiments as described herein relate to tool trays, toolboxes, and other similar mechanical tools, this is not intended to be limiting, and other use cases for the removable drawer system may also be applicable. For instance, a toolbox as described herein may, additionally or alternatively, be any similar box or similar structure configured to house a plurality of removable drawers (e.g., shelves, refrigerators, or similar).

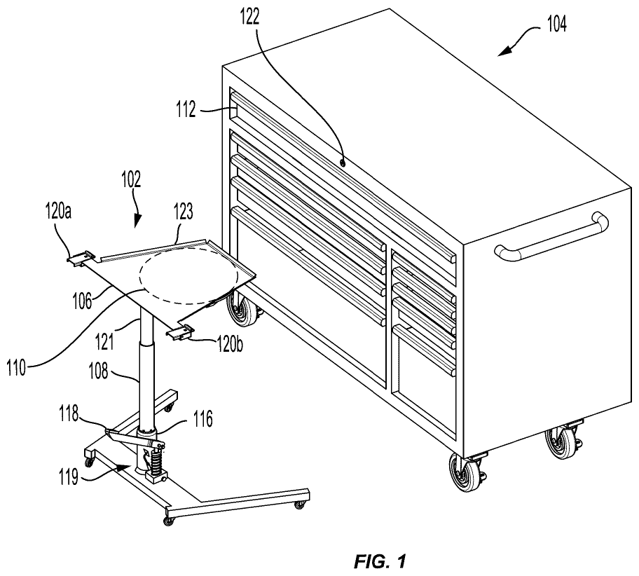

Referring now to the figures, FIG. 1 depicts an isometric view of a removable drawer system 100 including a rolling tool tray 102 and a toolbox 104. As described with respect to FIG. 1, the rolling tool tray 102 may be configured to releasably couple with at least one removable drawer (e.g., drawer 112) of the toolbox 104. The rolling tool tray 102 and the drawer 112 may each include components that enable a user to securely mount drawer 112 to the rolling tool tray 102. For example, the rolling tool tray 102 can include a plate 106 or similar mounting structure that is configured to attach, interlock, or otherwise engage with a removable drawer of the toolbox 104. Similarly, while FIG. 1 describes the toolbox 104 as a container comprising storage units (e.g., removable drawers) for tools, repair parts, and the like, the toolbox 104 may additionally or alternatively be utilized to store and otherwise house various types of materials, equipment, etc.

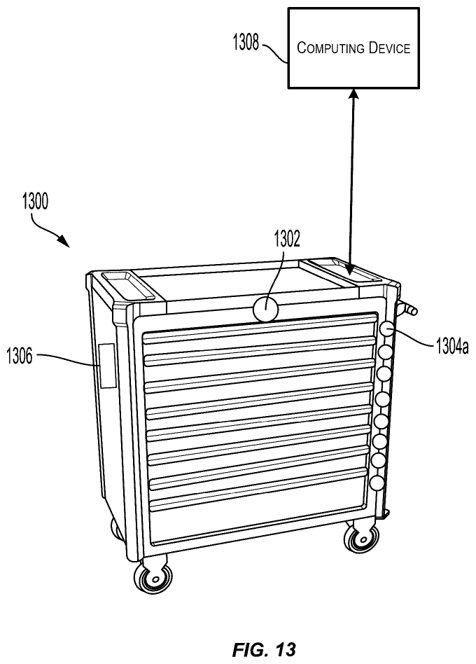

The removable drawer system 100 includes a rolling tool tray 102 and a toolbox 104. The toolbox 104 can include multiple drawers (e.g., drawer 112). At least one drawer (e.g., drawer 112) of the toolbox 104 may be slidably moveable out of the toolbox 104. The toolbox 104 may retain supplies including, but not limited to, hand tools and repair parts. Each drawer may be preset for a different repair job. In some cases, presetting a drawer can include preparing the drawer with tools for a specific repair type. As an example, a first drawer may include tools for an oil change, a second drawer may include tools for an engine repair, a third drawer may include tools for a tire rotation, etc. In some examples, the toolbox 104 may be used in an automotive environment, and each drawer may be preset with tools and/or parts for a different car. As an example, an auto mechanic may preset each drawer to include materials associated with a particular car by presetting a first drawer to include tools and parts for a BMW, a second drawer to include tools and parts for a Ford, etc. Each drawer may be divided into compartments to separate tools. In some examples, a drawer may include a foam insert or other common organizational features to divide the drawer or otherwise retain the tools therein. The drawers of the toolbox 104 may vary in size and may be of varying dimensions, depths, widths, lengths, and the like. In some examples, the toolbox 104 can include a locking component 122, as described in more detail with respect to FIG. 13.

The rolling tool tray 102 may be standardized for each removable drawer of the toolbox 104 and may accordingly be configured to releasably couple with each removable drawer of the toolbox 104. Such removable drawers may include a drawer coupling structure (also referred to herein as a “receiving structure”) configured to couple with the rolling tool tray 102 (or a component of the rolling tool tray 102, such as plate 106). The rolling tool tray 102 may be used to remove drawers of varying sizes from the toolbox 104. In some examples, the plate 106 may be configured to couple with a standard drawer coupling structure attached to or integrally formed with each drawer of varying size. Additionally, or alternatively, the plate 106 may be swapped to accommodate drawers of different sizes. For instance, the rolling tool tray 102 may be used to remove a wide drawer of the toolbox 104 using a first plate. A second plate may be swapped with the first plate to use the rolling tool tray 102 to remove a narrow drawer.

The rolling tool tray 102 may include or otherwise be formed with a support structure (e.g., frame 108) that may connect various components of the rolling tray 102 (e.g., rolling support platform) into a single moveable structure. For instance, the frame 108 may be integrally formed with or attached to one or more wheels that can enable the rolling tool tray 102 to maneuver by rolling. In some examples, the wheels may be attached to a rolling platform (e.g., a dolly, rolling legs, or similar) connected to the frame 108 that enables the rolling tool tray 102 to move by rolling.

Additionally, or alternatively, the rolling tool tray 102 includes a lifting mechanism 116 configured to adjust a vertical height of the rolling tool tray 102 with respect to the ground. The lifting mechanism 116 may enable a user to raise and/or lower the rolling tool tray 102 to a vertical height of a drawer (e.g., drawer 112) in the toolbox 104. The lifting mechanism may include mechanical components, hydraulic components, electrical components, or any other suitable components to enable vertical lifting. As examples, lifting mechanism 116 can be a hydraulic lift, linear actuator, linear motor, scissor lift, chain lift, etc. In some examples, as depicted in FIG. 1, the rolling tool tray 102 can include a foot pedal 118 coupled to a hydraulic cylinder 119. Application of a force on the foot pedal 118 can cause the hydraulic cylinder 119 to extend and retract a telescoping column 121 that effectively raises and lowers the plate 106 to a desired height. By way of example, the lifting mechanism 116 may be a hydraulic lift and the plate 106 may be raised to a vertical drawer 112 (or a component thereof) via application of a force on the foot pedal 118 to cause the hydraulic cylinder 119 to extend the telescoping column 121.

The frame 108 may additionally include an extending component within the frame 108 (e.g., an extension pole) that can enable the frame to support vertical movement of the plate as a lifting mechanism is activated. The extension pole or similar connective structure of the frame 108 may be positioned offset from the center of the plate 106 to enable the rolling tray 102 to wholly engage with an intended drawer of the toolbox 104. For instance, the extension pole may be positioned at a distance from the leading edge of the plate 106 that is at least the length of a receiving structure one or more removable drawer.

The rolling tool tray 102 includes plate 106, to which a removable drawer (e.g., drawer 112) can be mounted and releasably coupled to enable efficient movement and transportation of the removable drawer. The plate 106 may be formed in a variety of suitable shapes and configurations that are compatible with inserting into or otherwise engaging with a corresponding receiving structure of a removable drawer of the toolbox 104. The plate 106 may define a coupling structure 123 that can be coupled with a drawer coupling structure (e.g., a receiving structure of a drawer). In some embodiments, as depicted in FIG. 1, the plate 106 is defined by a trapezoidal shape with a leading side (i.e., a shorter parallel side of the trapezoid) and a trailing side (i.e., a longer parallel side of the trapezoid). The leading side of the plate 106 may be defined as the side that first engages with a receiving structure of a removable drawer. While certain figures and description herein describe the plate 106 with respect to this trapezoidal shape, this is not intended to be limiting, and various other shapes and arrangements of components may exist.

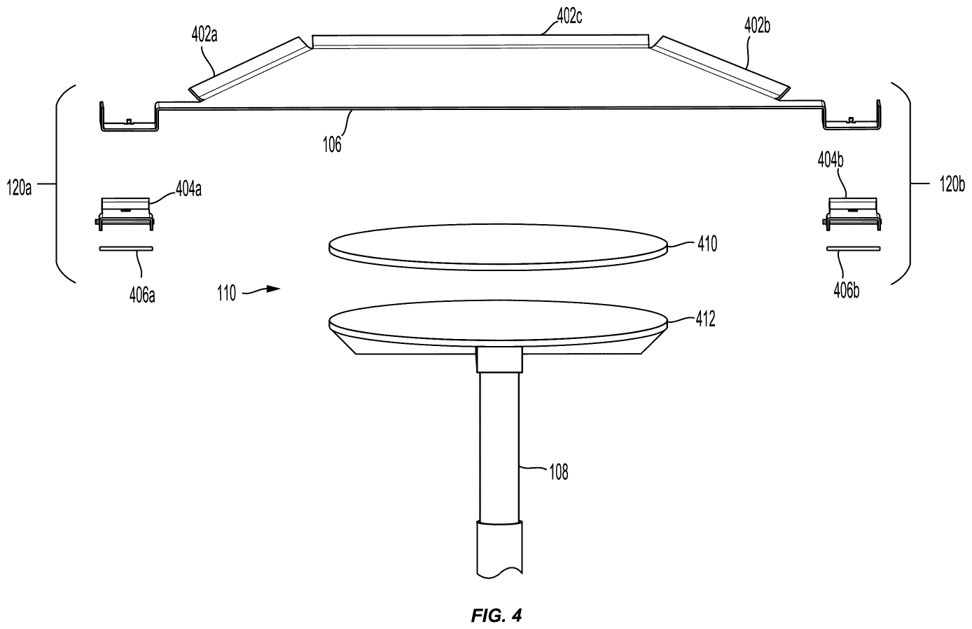

As described in more detail with respect to FIG. 4, the plate 106 can include a set of engagement faces that extend from the flat (trapezoidal) surface of the plate. Such engagement faces may be angled upward and may extend away from the center of the plate 106. These engagement surfaces may enable the plate 106 to engage with a corresponding receiving structure of a removable drawer to mount the drawer onto the rolling tool tray 102 and releasably couple the drawer 112 and the rolling tool tray 102 in a secure manner.

In some embodiments, the plate 106 may include latching mechanisms 120a-120b, which can be used to additionally secure the plate 106 to a drawer when mounting the drawer 112 to the plate 106. While FIG. 1 depicts the rolling tool tray 102 as including two latching mechanisms 120a-120b, some embodiments may include more or fewer latching mechanisms than depicted. The latching mechanisms 120a-120b may each include a latch that can secure the plate 106 from movement in a direction opposing the direction in which the plate 106 is inserted into the receiving structure of the removable drawer. Additionally, or alternatively, the rolling tool tray 102 can include a rotating platform 110 (e.g., a rotating disk colloquially referred to as a “Lazy Susan”) that can be utilized to rotate a direction of the plate 106 (e.g., a direction in which a leading side of the plate 106 faces).

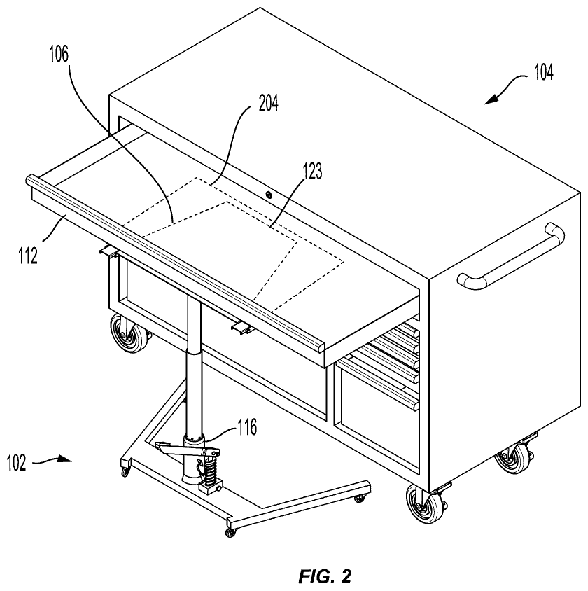

FIG. 2 depicts an isometric view of a removable drawer system 100 including a drawer 112 of toolbox 104 being mounted to the rolling tool tray 102, in accordance with various embodiments. Certain aspects of FIG. 2 are described with respect to components of the removable drawer system 100 of FIG. 1. As depicted in FIG. 2, the rolling tool tray 102 can be configured to releasably couple with a removable drawer 112 of the toolbox 104. As described herein, the rolling tool tray 102 may be configured to adjust the height of the plate 106 to match that of the removable drawer 112. Then, the coupling structure 123 of the plate 106 can be inserted into a corresponding drawer coupling structure 204 of the removable drawer 112. The drawer coupling structure 204 of the removable drawer 112 may be defined on an underside of the removable drawer 112. For example, the drawer coupling structure 204 may be a separate part that is attached to or other otherwise mounted to the underside of the removeable drawer 112, may be integrally formed or otherwise biased into the removable drawer 112, or defined in any other suitable manner. To mount the drawer 112 to the rolling tool tray 102, the rolling tool tray 102 may be releasably coupled to the drawer 112 by releasably coupling the plate 106 to the drawer coupling structure 204 via complementary engagement faces of plate 106 and drawer coupling structure 204 and by engaging latching mechanisms 120a-120b. Upon releasably coupling rolling tool tray 102 and drawer 112, the rolling tool tray 102 and drawer 112 may be moved as a single unit and the drawer 112 can be removed from the toolbox 104 by moving the rolling tool tray 102 in a direction away from the toolbox 104.

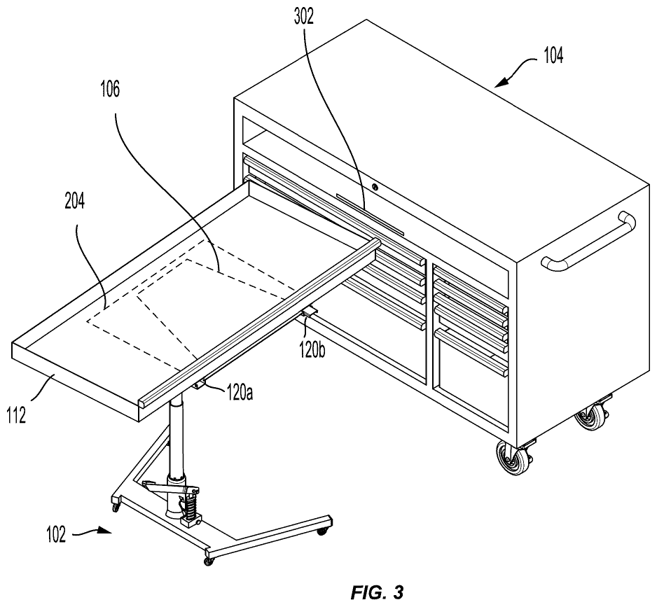

FIG. 3 depicts an isometric view of a removable drawer system 100 including a removable drawer 112 of a toolbox 104 mounted to a rolling tray 102 and rotated, in accordance with various embodiments. As depicted in FIG. 3, the removable drawer 112 can be removed from the toolbox and mounted to rolling tool tray 102. The drawer 112 may be mounted to the rolling tool tray 102 by engaging the plate 106 of the rolling tool tray 102 with the drawer coupling structure 204 of the drawer 112. In some embodiments, the plate 106 and the corresponding drawer coupling structure 204 may be releasably coupled by inserting the plate 106 into the drawer coupling structure 204 such that the respective engagement surfaces of the plate 106 and the drawer coupling structure 204 come into physical contact, and by engaging latching mechanisms 120a-120b to prevent movement in a direction opposing the direction in which the plate 106 is inserted into the drawer coupling structure 204. Upon mounting the drawer 112 to the rolling tool tray 102, the plate 106 of the rolling tool tray 102 can be rotated via the rotating platform 110 to turn the drawer at a preferred angle for the operator of the rolling tool tray 102. For example, the removable drawer 112 can be rotated to an orientation that is at a 90° angle with respect to an original orientation of the drawer 112 as depicted in FIG. 3.

A slot that houses the removable drawer 112 can include a hard stop 302 that secures the removable drawer within the toolbox 104. The hard stop 302 may be defined on a set of drawer slides within the slot. For instance, the hard stop 302 may extend between drawer slides on each respective end of the slot and may connect the drawer slides. The removable drawer 112 may be configured to be pulled out of the slot until a tab, projection, drawer member, or other drawer component is stopped by the hard stop 302. By way of example, the slot can include drawer slides that house a plurality of rollers (e.g., wheels). The removable drawer 112 may be supported on the plurality of rollers within the slot such that the drawer can roll over the rollers and be slid outwardly from the slot. The hard stop 302 may prevent movement in a direction outside of the toolbox (e.g., in an x-direction as depicted in FIG. 3). To remove the drawer 112, the plate 106 may be attached to the drawer 112, the drawer 112 may be pulled out until resistance with the hard stop is met, and lifting mechanism 116 can be activated to lift the drawer above and over the hard stop 302 and remove the drawer from the slot.

In some examples, the hard stop 302 may be defined as part of a drawer slide assembly by which the removable drawer 112 is connected to the slot of the toolbox 104. The drawer slide assembly for may include high-capacity industrial slides designed to enable transfer of tool trays while supporting significant weight. These slides are engineered to handle heavy loads, specifically rated to support weights ranging from 200 lbs to 400 lbs. The removable drawer 112 may be constructed from simple sheet steel and may not have slides or rollers permanently mounted to them. Instead, all mechanical roller components and sliding hardware may be situated on the storage racks or the toolboxes. The slide mechanism utilizes a multi-stage extension design to allow the removable drawer 112 to extend fully outside of the toolbox 104. For example, an intermediate slide member extends approximately halfway from the toolbox 104, while the drawer 112 itself extends the remaining distance to provide total clearance. This telescoping action has been optimized for high-load industrial environments where full access to the contents of the drawer 112 is desirable.

The drawer 112 may be primarily retained via a gravity-based interface. The slides are held in place using a combination of gravity and sheet metal hard stops rather than a traditional mechanical locking or release trigger. This configuration enables the drawer 112 to be removed simply by lifting it vertically off the slides once they are in the fully extended position.

To ensure structural integrity and ease of alignment during re-entry, the left and right drawer slides are physically tied together via a crossbar or plate situated underneath the drawer 112. This plate ensures the slides operate in parallel and move in unison, which is essential for providing a stable platform for the drawer 112 that may be loaded manually or “blind”. When the slides are fully extended, this crossbar is positioned at the outlet of the toolbox 104, remaining far enough toward the rear to provide clearance for the substructure of the drawer 112, while still providing a robust support base.

Examples of suitable slides include a mechanical profile that is analogous to high-performance industrial slides from manufacturers, such as those offered by Global Industrial. Such slides allow for the “lift-off” removal of the drawer box, without requiring the manipulation of a disconnect lever. For example, the hard stop 302 may be formed in the crossbar of the slides that extends between and connects a pair of drawer slides. This structure may be part of the drawer slide structure that remains in the toolbox 104 when the removable drawer 112 is removed. In this example, to remove the removable drawer 112, the removable drawer 112 may be pulled out as far as the drawer slides will permit, then the removable drawer 112 may be lifted to overcome the hard stop 302.

FIG. 4 depicts an exploded view of a rolling tool tray 102, according to at least one example. The rolling tool tray 102 as depicted in FIG. 4 comprises a plate 106 defining a coupling structure of a removable drawer system. The plate 106 may be or may include a coupling structure that can engage with a receiving structure of the removable drawer. The plate 106 as depicted in FIG. 4 includes a set of engagement faces 402a-402c extending from the plate 106. These engagement faces 402a-402c may be angled surfaces extending from the plate 106 that enable the plate 106 to engage with a receiving structure of a removable drawer. The engagement faces 402a-402c may engage with the receiving structure via an outer side of the engagement faces 402a-402c (e.g., a side that is opposite the side of each engagement face visible in FIG. 4). By way of example, the engagement faces 402 a-402c may be angled at 45° with respect to a flat surface (e.g., trapezoidal surface) of the plate 106. The engagement faces 402a-402c may enable releasably coupling plate 106 to a receiving structure of drawer 112 in a manner such that movement between the rolling tool tray 102 and the respective drawer 112 is restrained across a plurality of directions. The engagement faces 402a-402c may, alternatively, be referred to as “contact surfaces,” “mating faces,” “interlocking surfaces,” or similar.

In some embodiments, the engagement faces 402a-402c may be or may include one or more dovetail components (also referred to as “tenons,” “projections,” etc.). A dovetail component can refer to a component with angled, flared, projecting, or similar, sides that enable secure and semi-permanent alignment between the dovetail component and a corresponding receiving component (e.g., dovetail groove, female component, etc.). A dovetail component generally refers to components with flared edges and that may be oriented in opposing directions (e.g., in the shape of a tail, wedge, trapezoid, etc.). As such, engagement faces 402a and 402b may be referred to as a “dovetail component” and engagement face 402c, which may not have a corresponding flared edge oriented in an opposing direction, may be referred to as a “half-dovetail component” or a “single-dovetail projection.”

In some examples, each engagement face 402a-402c can be bidirectional. In such examples, the engagement face 402a-402c can include a first surface angling outward connecting to a second surface angling inward. The use of a bidirectional engagement face can enable restraint of the plate 106 to the drawer 112 across all degrees of freedom based on physical contact between the engagement face 402a-402c and a corresponding receiving structure component as described in more detail below.

In some embodiments, plate 106 may be mounted to rotating platform 110 (e.g., Lazy Susan). The rotating platform 110 may be configured to enable the plate 106 to rotate. The rotating platform 110 may include a rotating circular plate 410 mounted on a stationary circular plate 412. The rotating circular plate 410 may be configured to rotate with respect to an axis of rotation extending vertically through the rotating circular plate 410 and the stationary circular plate 412. The axis of rotation may be defined by a central pivot (e.g., a rod, etc.) between the rotating circular plate 410 and the stationary circular plate 412 that provides a fixed center of rotation. In some examples, the rotating circular plate 410 may be mounted to the stationary circular plate 412 via a bearing assembly, which may enable rotational movement of the rotating circular plate 410. Plate 106 may be rotated when a drawer is attached to the plate 106, which can enable an operator of the rolling tool tray to rotate and otherwise determine a new position for the tool tray. In some embodiments, the rotating platform 110 may include a peg configured to lock a position of the rotating platform 110. For instance, the rotating platform 110 may be rotated to a particular position (e.g., a position facing toolbox 104), and the peg may be affixed to lock the plate 106 in its current orientation. Additionally, or alternatively, the rolling tool tray 102 may include one or more latching mechanisms 120a-120b comprising a latch 404a-404b and a latch pin 406a-406b. The latch pins 406a-406b may secure each respective latch 404a-404b to the plate 106 in a predetermined position (e.g., via a spring).

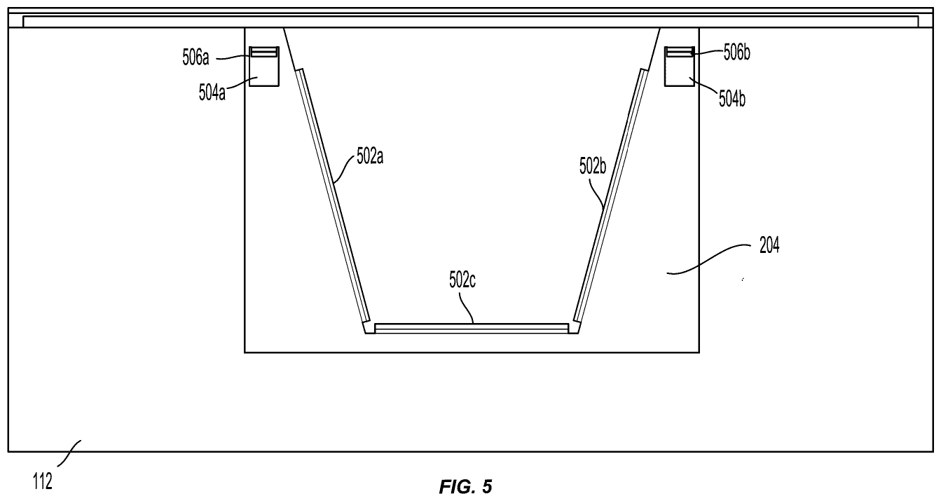

FIG. 5 depicts a plan view of a removable drawer in accordance with various embodiments. Specifically, FIG. 5 depicts an underside of drawer 112 of the toolbox 104 of FIGS. 1-3. The removable drawer 112, as depicted in FIG. 5, includes a drawer coupling structure 204 that is configured to engage with a rolling tool tray 102 (e.g., with plate 106 as described with respect to FIGS. 1-4). The drawer coupling structure 204 may be attached to or integrally formed with the drawer 112. The drawer coupling structure 204 may be referred to as a “reciprocal dovetail plate,” a “female dovetail plate,” or similar. The drawer coupling structure 204 can include a set of engagement faces 502a-502c that are reciprocal to the engagement faces of the plate 106 (e.g., engagement faces 402a-402c). For example, the engagement faces 502a-502c of the drawer coupling structure 204 as depicted in FIG. 5 may be angled inward (e.g., towards the center of the removable drawer 112). Accordingly, the engagement faces 502a-502c of the drawer coupling structure 204 may come into physical contact with engagement faces 402a-402c of the plate 106 to interlock with the respective engagement faces 402a-402c of the plate 106 and restrain movement of the plate 106. In some embodiments, the engagement faces 502a-502c form a groove (e.g., a dovetail groove, recess, etc.) with respect to a flat surface of the of the drawer, and the engagement faces 402a-402c of the plate 106 may be configured to align and slide into the groove, which can enable interlocking of the respective engagement faces for the plate 106 and drawer coupling structure 204. Interlocking of the respective engagement faces can include alignment of projection components (e.g., engagement faces 402a-402c) with corresponding grooves (e.g., as formed by engagement faces 502a-502c) and sliding the respective engagement faces into a position where physical contact and/or friction between the engagement faces prevent the engagement faces from disengaging. In some examples, a gasket may be implemented between engagement face 402a and engagement face 502a and/or between engagement face 402b and engagement face 502b. A gasket between these engagement faces may be structured similarly to a gasket between engagement face 402c and engagement face 502c but may be configured to provide improved sliding as plate 106 is inserted into drawer coupling structure 204.

As depicted in FIG. 5, the drawer coupling structure 204 can include a set of corresponding receiving areas 504a-b that may be configured to secure the plate to the receiving structure (i.e., the removable drawer) with a latch 404. Each receiving area 504a-b may include a notch 506a-b that the latch 404 may engage with to secure the rolling tool tray 102 to the drawer 112.

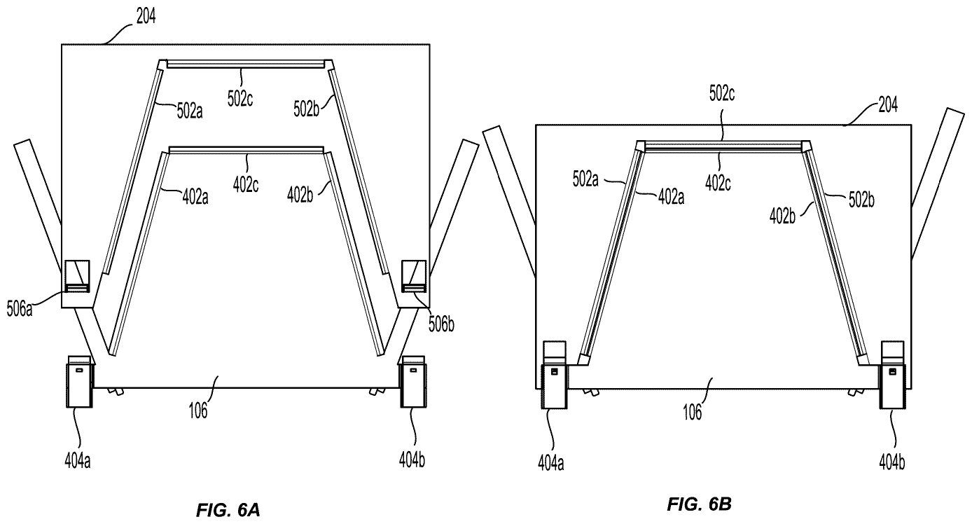

FIGS. 6A-6B depict plan views of the drawer coupling structure 204 of the removable drawer 112 engaging with the plate 106 of the rolling tool tray 102. Removable drawer 112 is not depicted in FIGS. 6A-6B to more clearly illustrate the drawer coupling structure 204 and engagement between the drawer coupling structure 204 and the removable drawer 112. FIG. 6A depicts the drawer coupling structure 204 and the plate 106 in an unengaged state (e.g., immediately prior to engaging with the receiving structure or immediately after being detached from and/or engaging with the receiving structure). As depicted in FIG. 6A, each respective engagement face 402a-402c of the plate 106 may have a corresponding, reciprocal engagement face in the drawer coupling structure 204 of the removable drawer. As depicted in FIG. 6B, engagement faces 402a-c of the plate 106 may interlock or otherwise engage with corresponding engagement faces 502a-c of the drawer coupling structure 204. Each respective engagement face may be oriented in a direction as to enable such interlocking of the engagement faces such that movement of the plate 106 is restrained in all Cartesian directions. For instance, the engagement faces 502a-502c may create a groove that the engagement faces 402a-402c of the plate 106 may align with and thus slide into as the plate 106 is inserted into the drawer coupling structure 204. The plate 106 and drawer coupling structure 204 may be considered to be in an engaged state when engagement faces 402a-c and engagement faces 502a-c are in physical contact and when latches 404a-404b are releasably coupled with a corresponding latch component of drawer coupling structure 204 (e.g. notches 506a-506b).

In some embodiments, a gasket may be placed between one or more pairs of complementary engagement faces of the plate 106 and the drawer coupling structure 204. For instance, a gasket may be mounted to engagement faces extending from or complementary to a leading edge of plate 106 (e.g., engagement face 402c, engagement face 502c, or both). This may cause compliance between engagement face 402c and engagement face 502c as plate 106 is pushed forward to engage with drawer coupling structure 204. The gasket may compress as engagement face 402c and engagement face 502c are brought closer together. This can prevent latches 404a-404b from rattling when coupled with notches 506a-506b and may provide an additional force to secure plate 106 to drawer coupling structure 204. The additional force may be in a direction opposing a force generated by latches 404a-404b when coupled with notches 506a-506b. For example, the use of the gasket may prevent unwanted movement in a forward and backward direction with respect to a direction in which the plate 106 is inserted into the drawer coupling structure 204.

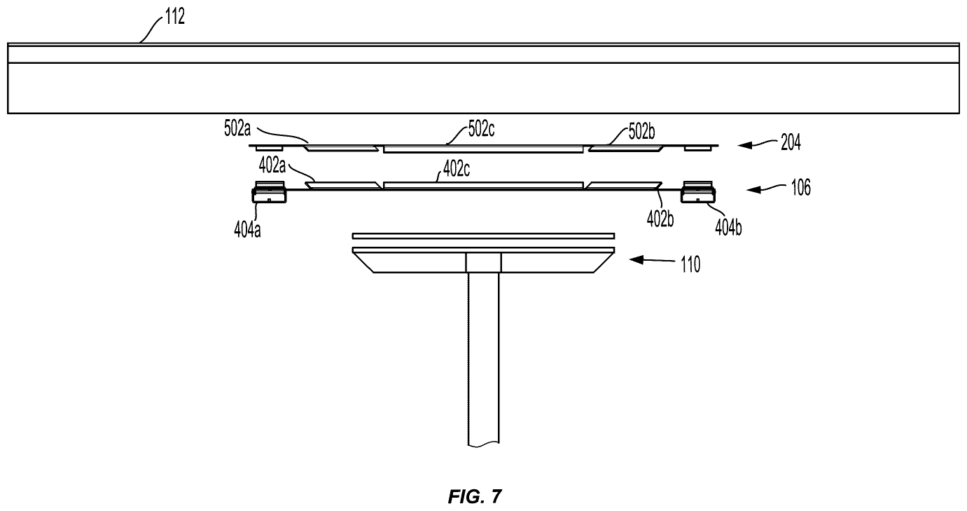

FIG. 7 depicts an exploded view of various components of a removable drawer 112 and a rolling tool tray 102, in accordance with at least one embodiment. The removable drawer 112 can include a drawer component configured to hold one or more tools (or alternative objects) as described above with respect to FIGS. 1-6. Additionally, the removable drawer 112 can include a reciprocal coupling structure 204 configured to engage with a coupling structure of the rolling tray (e.g., plate 106) to mount the drawer onto the rolling tool tray 102. As depicted in FIG. 7, the plate 106 of the rolling tool tray 102 may have reciprocal or otherwise complimentary structures. For instance, engagement faces 402a-402c of the plate 106 extends upward and outward, towards an outer edge of the plate 106. Engagement faces 502a-502c of the drawer coupling structure 204, conversely, extend downward and inward, towards a center of the plate 106. As such, each engagement face may be configured to securely interlock with a corresponding reciprocal engagement face. For instance, engagement face 402a of the plate 106 may be configured to interlock or otherwise physically engage with engagement face 502a of the drawer coupling structure 204, which can enable restraint of movement across vertical and horizontal directions.

The use of such engagement faces (e.g., dovetail components) may enable control over six degrees of freedom within three-dimensional space. For instance, the interlocking and alignment of the engagement faces of the plate 106 and the drawer coupling structure 204 may restrict movement in the X-, Y-, and Z-directions. For instance, in embodiments where the plate 106 is inserted into the drawer coupling structure 204 in the X-direction, the engagement faces may restrict movement of the plate 106 in a positive X-direction (e.g., towards the inside of the drawer coupling structure 204), but may not restrict movement in a negative X-direction (e.g., in a direction towards the outside of the drawer coupling structure 204). In such cases, the use of a latching mechanism (e.g., latching mechanism 122a) can further prevent mounting in the direction towards the outside of the drawer coupling structure 204 to entirely secure the plate 106 across all degrees of freedom.

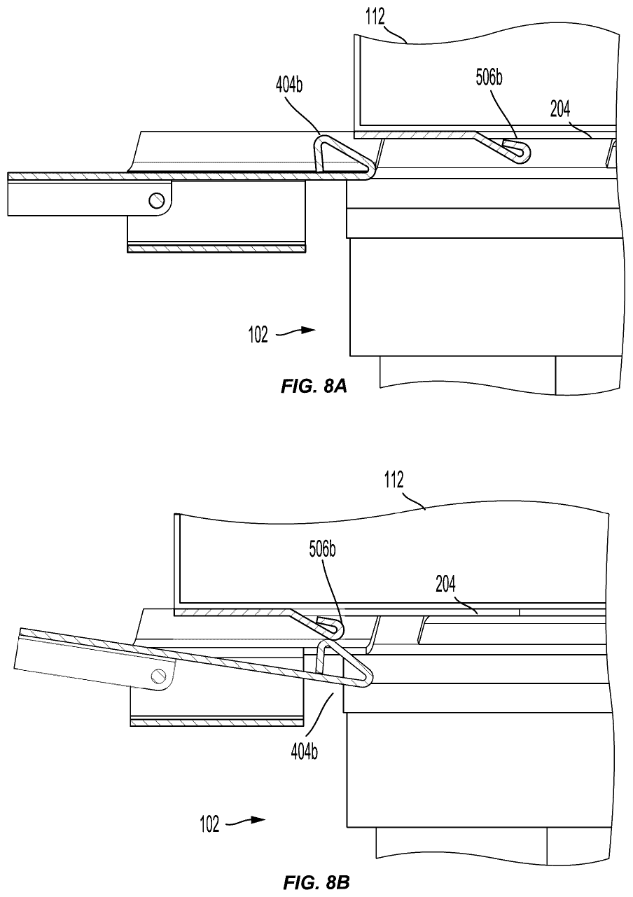

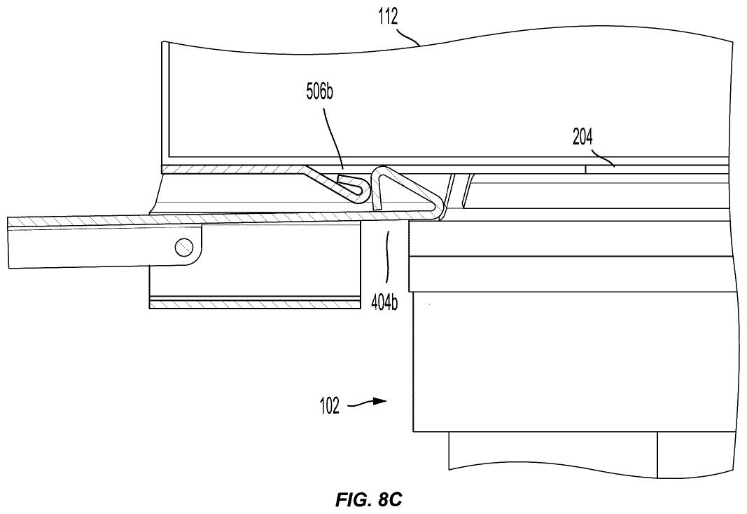

FIGS. 8A-8C depict a side view of a latching mechanism for securing a rolling tool tray 102 to a removable drawer 112, according to various embodiments. FIG. 8A depicts a view of a latching mechanism when inserting the plate 106 into the drawer coupling structure 204 of a removable drawer 112, prior to engagement of the latching mechanism. The latching mechanism can include a spring (not depicted) biased into to the system (e.g., within latch pin 416, etc.) that can bias the latch to a closed position. FIG. 8B depicts a view the latching mechanism 120 as the latch 404 is engaged while inserting the plate 106 into the drawer coupling structure 204 of the removable drawer 112. As the plate 106 is moved into the drawer coupling structure 204, physical contact between the notch 504 of the drawer coupling structure 204 and the latch 404 can depress the latch 404 (e.g., displace the latch downward vertically). This may increase pressure on the latching mechanism (e.g., on the spring or other similar component within the latching mechanism) as the latch is stretched in a vertical direction, thus increasing displacement between a current position of the latch 404 and a natural position of the latch 404.

FIG. 8C depicts a view of the latching mechanism in an engaged position. As depicted in FIG. 8C, upon surpassing a horizontal position of the notch 504 of the drawer coupling structure 204, the latch 404 may return to its natural vertical position. For instance, pressure may be released from a spring that has been stretched out upon moving past the notch 504, which may cause the spring to return to its natural position, thus causing a vertical position of the front end of the latch 404 to similarly return to a natural position. Upon returning to a natural vertical position as depicted in FIG. 8C, the plate 106 may be secured within the drawer coupling structure 204. The position of the notch 504 with respect to the latch 404 can prevent the latch 404 from moving backward without an external force causing the latch 404 to tilt downward and below the notch 504 (e.g., by an operator of the rolling tool tray 102 when returning drawer 112 to toolbox 104). Thus, the plate 106 may be prevented from unintentionally moving backward (e.g., out of the drawer coupling structure 204).

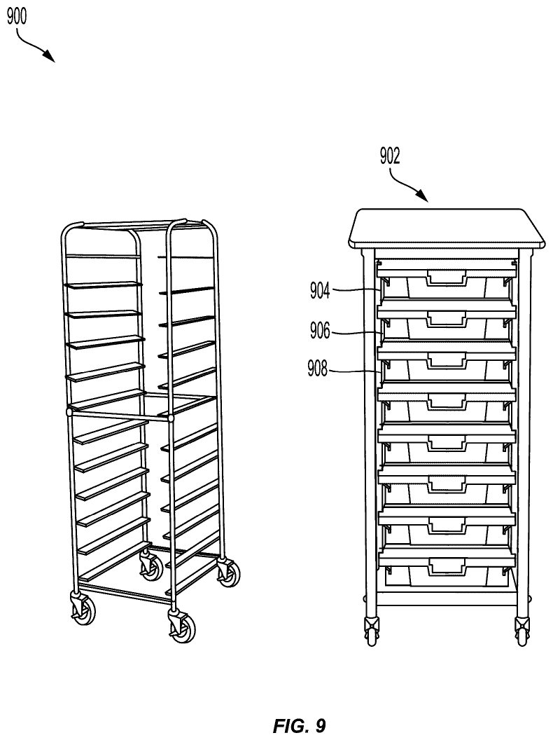

FIG. 9 illustrates an example racking systems, in accordance with various embodiments. Racking systems 900 and 902 may each include a plurality of horizontally stacked shelves. Racking system 900 depicts an empty racking system and racking system 902 is a racking system housing a plurality of containers (e.g., drawers, totes, etc.) For example, racking system 902 may hold containers 904-908. Some containers may be drawers removed from a toolbox (e.g., toolbox 104). Additionally, or alternatively, containers 904-908 may be storage units that are configured to hold, store, or otherwise contain materials and can mount to a supporting platform (e.g., a rolling tool tray) with a coupling structure as described above. For example, container 904 may be drawer removed from a toolbox by mounting to a rolling tool tray. Each container 904-908 may include a drawer coupling structure as described above. Accordingly, the rolling tool tray 102 may be configured to releasably couple with each respective container 904-908. The rolling tool tray 102 may interface with the racking system and be held within the stacked shelves. The racking system can include a coupling component that may releasably couple with the rolling tool tray 102. Each rack in the racking system may be configured to hold a tray. In some examples, a tray stored in the racking system can include car parts and/or other tools for auto repairs. In some embodiments, the racking system 900 may be oriented in a direction that is orthogonal to a direction in which drawers are oriented in the toolbox 104. For instance, drawers in the toolbox 104 may be oriented horizontally, while racks in the racking system may be oriented at a 90° orientation with respect to the orientation in the toolbox 104. In such examples, an operator of the rolling tool tray 102 may utilize the rotating platform 110 of the rolling tool tray 102 to rotate a drawer to an orientation supported by the racking system 900.

By way of non-limiting example, a mechanic may remove auto parts from a car and place the parts onto a parts tray mounted on the rolling tool tray 102. In some cases, a repair may take more than a day to complete, or a repair may include more parts than available space on a single tray. In such cases, the mechanic may deposit the parts trays into the racking system 900 by placing (e.g., by rolling) the rolling tool tray 102 in front of the racking system 900 and using the lifting mechanism 116 to adjust the height of the rolling tool tray 102 to a height of an empty rack. The rolling tool tray 102 can releasably couple with the racking system to enable a parts tray to slide into and/or out of the racking system 900.

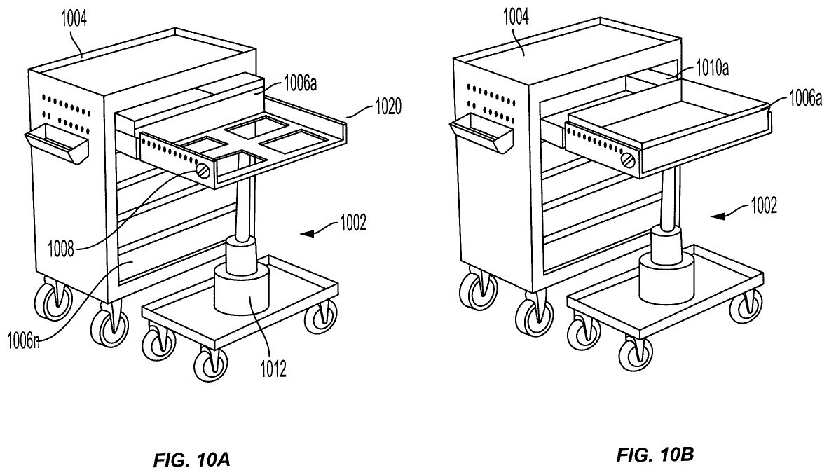

FIGS. 10A-10B show an alternative embodiment of an example removable drawer system 1000, according to at least one example. The removable drawer system 1000 includes a rolling tool tray 1002 (e.g., rolling tool tray 102) and a toolbox 1004 (e.g., toolbox 104). The rolling tool tray 1002 as depicted in FIGS. 10A-10B may include an alternative U-shaped coupling structure that houses a drawer 1006a to mount the drawer 1006a to the rolling tool tray 1002.

The rolling tool tray 1002 may be configured to releasably couple with a coupling component 1008 of the toolbox 1004. Examples of the coupling component 1008 include, but are not limited to, screws, pins, latches, tabs, ridges, etc. The rolling tool tray 1002 depicted in FIGS. 10A-10B may latch onto a surface and/or component of the toolbox 1004. The drawer 1006a may be housed in a slot 1010a. In some examples, the slot 1010a may include a rail (e.g., a drawer slide, runner, glide, etc.) that enables the drawer 1006a to slide. The coupling mechanism may be configured to releasably couple with the rail to enable the drawer 1006a to slide onto the rolling tool tray 1002. In some examples, a subsection of the drawer 1006a may be removable and may be attached to the rolling tool tray 1002 instead of or in addition to the entire drawer 1006a.

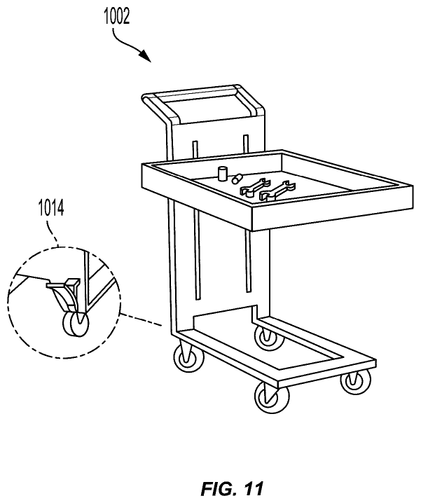

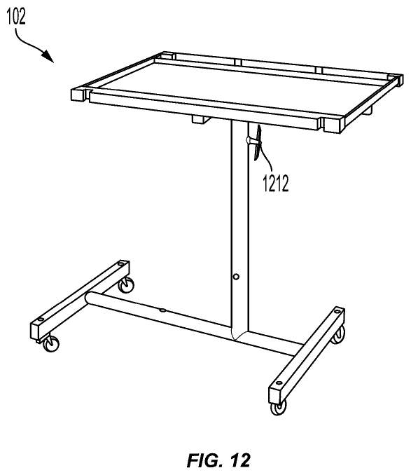

As depicted in FIG. 10B, the drawer 1006a may be configured to slide horizontally and mount onto the rolling tray 1002. The drawer 1006a may be secured in the tray with a second coupling component including, but not limited to, a lock, latch, screw, etc. In some examples, the drawer 1006a can include one or more drawer wheels positioned within a rail in slot 1010a. The rolling tool tray 1002 may include a receiving structure configured to house the drawer wheels when the drawer 1006a is mounted on the rolling tool tray 1002. Upon mounting and/or securing the drawer 1006a onto the rolling tool tray 1002, the coupling component 1008 may be released. The rolling tray 1002, including drawer 1006a, may be transported (e.g., rolled) to a different location. As described above, the rolling tool tray 1002 includes a lifting mechanism 1012 (e.g., lifting mechanism 116) configured to adjust a vertical height of the rolling tool tray 1002 with respect to the ground. In some examples, as depicted in FIG. 11, the rolling tool tray 1002 can include a pedal 1014. The pedal 1014 may be an example of foot pedal 118 as described above with respect to FIG. 1. Application of a force on the pedal 1014 can cause the tray to raise and/or lower to a desired height. For example, as described with respect to FIG. 1, the lifting mechanism 1012 may be a hydraulic lift and application of force to the hydraulic lift may cause the tray to adjust in vertical height.

By way of non-limiting example, a mechanic performing a brake job on a BMW can place the rolling tool tray 1002 in front of the toolbox 1004 to retrieve a preset drawer 1006n containing parts and tools for brake jobs for the BMW. The mechanic can adjust the rolling tool tray 1002 to a height of the drawer 1006n using lifting mechanism 1012. Upon reaching a desired height, the mechanic can latch the rolling tool tray 1002 to the toolbox 1004 and mount the drawer 1006n onto the rolling tool tray 1002 by sliding the drawer 1006n onto the rolling tool tray 1002. The mechanic can unlatch the rolling tool tray 1002 and the toolbox 1004, readjust the height of the rolling tool tray 1002 via the lifting mechanism 1012, and move the rolling tool tray 1002 with the mounted drawer 1006n to the car. Upon finishing the brake job, the mechanic can place the rolling tool tray 1002 in front of the toolbox 1004, adjust the height of the rolling tool tray 1002 to the height of a slot 1010n, latch the rolling tool tray 1002 to the toolbox 1004, and slide the drawer 1006n back into the slot 1010n in the toolbox 1004.

In some examples, the toolbox 1004 can include a drawer 1006a with a tilting mechanism configured to enable a drawer to tip forward at an angle while sliding out of the toolbox 104. The drawer 1006a may include a magnetic component configured to hold one or more tools in place while the drawer 1006a is positioned at an angle. The rolling tool tray 1002 may be configured to be placed over the engine of a vehicle. In some examples, the rolling tool tray 1002 may be incorporated into a light bar spanning an engine block and configured to hang from the hood of a vehicle.

FIG. 12 illustrates an alternative depiction of rolling tool tray 102. As depicted in FIG. 12, in some embodiments, the lifting mechanism may be activated manually and held in place using a locking component 1212 (e.g., a hand crank, motorized crank, lever, screw, pulley, etc.) that can be used for adjusting a height of the rolling tool tray 102. In some examples, the rolling tray 102 may be collapsable and may be placed in a parking spot in the removable drawer system 100 (e.g., a compartment in toolbox 104). In some examples, rolling tool tray 102 can be battery-powered, including an automated lifting mechanism, which may be controlled by a button, remote control, software application, etc.

FIG. 13 illustrates an alternative example of a rolling toolbox 1300, according to at least one example. The rolling toolbox 1300 includes drawers as described above and is an example of the toolbox 104. The drawers of the rolling toolbox 1300 may be uniform or vary in size. The rolling toolbox 1300 may interface with a tool tray (e.g., rolling tool tray 102). The toolbox 1300 can include a locking mechanism 1302. The locking mechanism 1302 may be mechanical, computer-implemented, or a combination thereof. As an example, the locking mechanism 1302 can include a key fob that locks and/or unlocks the toolbox 1300 based on a proximity of the key fob to the toolbox 1300 or a click of a button on the key fob. As another example, the locking mechanism 1302 may be unlocked by a mobile device. The locking mechanism 1302 may use a proximity of a cell phone or a device including a geolocation service to unlock the toolbox 1300. A software component on the mobile device (e.g., application, etc.) may be configured to unlock the locking mechanism 1302. In some examples, the locking mechanism 1302 can include a physical key and lock.

In some examples, the toolbox 1300 may be lockable via any suitable mechanism, which may include a key, a wireless key (e.g., a fob, a credential on a mobile phone, etc.), and/or any other suitable mechanism. In some examples, each drawer in the toolbox 1300 may be independently lockable. Such access control may be helpful for limiting use of tools in the different drawers. For example, the toolbox 1300 may be shared by multiple mechanics, with each having their own lockable and removable drawer. In some examples, a computing device 1308 may be included onboard or as part of the toolbox 1300. Additionally, or alternatively, the computing device the toolbox 1300 may be communicatively coupled to computing device 1308 remotely, via a network connection. In this example, the computing device 1308 may be used to access the drawers (e.g., lock and unlock), validate credentials for access, and otherwise manage access control to the opening and removing the drawers. In some cases, such computer control may also provide for tracking of access and use of the tools over time.

In some examples, each drawer in the rolling toolbox 1300 may include an identifier. The identifier may allow a user to access information about the contents of the drawer and other identifiers. The identifier can be a barcode, radio frequency identification (RFID) tag, Bluetooth identifier, and/or the like. As an example, a user may scan a barcode for a drawer to identify contents of the drawer. Information about the contents of the drawer may be presented to a user through an external application, website, etc. In some examples, each drawer is associated with a drawer lock 1304. The drawer lock 1304 may be the same as or different from the locking mechanism 1302 for the entire toolbox 1300. Each drawer may be associated with a user, and the user may lock and unlock the drawer lock 1304 using a unique key.

The rolling toolbox 1300 may include a universal power supply (UPS) system 1306. The UPS system 1306 can be configured to provide power to electrical and battery-powered components of a rolling tool tray and/or other electronic devices (e.g., a cellphone, battery-powered hand tools, etc.). Alternatively, or additionally, the toolbox 1300 may include an inverter configured to charge or provide power to electrical components. In some examples, the rolling toolbox 1300 may be used as a rolling cart that can be moved to a secondary location (e.g., in front of a car engine). In such examples, the rolling toolbox 1300 may be smaller than a large toolbox (e.g., toolbox 104) and the UPS 1306 can be used to power supplies and tools at a repair site.

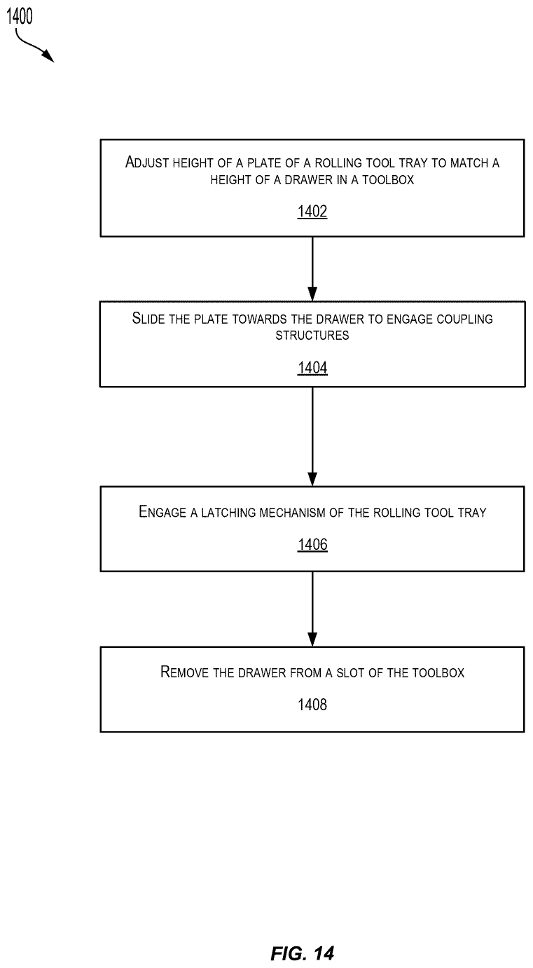

FIG. 14 depicts an example method 1400, in accordance with various embodiments of the present disclosure. It should be appreciated that the operations of the method 1400 may be performed in any suitable order, not necessarily the order depicted in FIG. 14. Further, the method 1400 may include additional, or fewer operations than those depicted in FIG. 14. The operations of method 1400 may be performed by any suitable storage transportation technique, user operating a rolling tool tray, or similar. Certain aspects of FIG. 14 are described with respect to components described above with respect to FIGS. 1-13.

At block 1402, the method 1400 can include adjusting a vertical height of a plate (e.g., plate 106) of a rolling tool tray (e.g., rolling tool tray 102) to a height of a drawer (e.g., drawer 112) held in a slot of a toolbox (e.g., toolbox 104). The vertical height of the plate may be adjusted via a lifting mechanism of the rolling tool tray 102. For example, the rolling tool tray may include a hydraulic lift configured to raise and/or lower a plate of the rolling tool tray. As a particular example, the rolling tool tray can include a foot pedal coupled to a hydraulic cylinder. In such examples, the vertical height of the plate may be adjusted by applying a force on the foot pedal to cause the hydraulic cylinder to extend and/or retract a telescoping column of the rolling tool tray.

At block 1404, the method 1400 can include sliding the plate towards the drawer to engage respective coupling structures of the plate and the drawer. The plate can include a plate coupling structure (e.g., coupling structure 123) and the drawer can include a drawer coupling structure (e.g., drawer coupling structure 204). Each coupling structure can include a set of engagement faces that are complementary to an engagement face of the corresponding coupling structure. For example, the plate coupling structure can include a set of angled surfaces that extend upward and outward with respect to a top surface of the plate and the drawer coupling structure can include a set of angled surfaces that extend downward and inward with respect to a bottom surface of the drawer. The coupling structures may be engaged by aligning corresponding engagement surfaces and sliding the plate towards the drawer until a leading edge of the plate (e.g., engagement surface 402c) interlocks with a corresponding engagement surface of the drawer coupling structure (e.g., engagement surface 502c). Sliding the plate towards the drawer can involve moving the rolling tool tray towards the toolbox (e.g., by rolling the tool tray via wheels of the tool tray).

At block 1406, the method 1400 can include engaging a latching mechanism of the plate. The latching mechanism can involve a latch that is biased towards a certain position (e.g., using a spring). As the plate is moved towards the drawer at block 1404, the latch may be displaced downward, due to physical contact with a notch of the drawer coupling structure. Upon engaging the engagement faces of the respective coupling structures, the latch may be moved to a horizontal position past the notch, and may thus automatically return to a natural vertical position. As such, the relative position of the notch to the latch may prevent movement of the plate out of the drawer coupling structure.

At block 1408, the method 1400 can include removing a drawer from a slot in the toolbox. To remove the drawer, the rolling tool tray may be moved in a direction opposite to the direction in which the plate was inserted into the drawer coupling structure. For example, if block 1404 involves a user performing a forward-pushing motion to insert the plate into the drawer coupling structure, the user may perform a backward-pulling motion to remove the drawer from the toolbox.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A removable drawer system, comprising:
a toolbox comprising a plurality of removable drawers, wherein at least one removable drawer comprises a first coupling structure defined at an underside; and
a rolling tool tray comprising:
a plate defining a second coupling structure configured to releasably couple with the first coupling structure of the at least one removable drawer;
a latching mechanism configured to releasably couple with a latch component of the at least one removable drawer; and
a lifting mechanism configured to adjust a vertical height of the plate.

2. The removable drawer system of claim 1, wherein the first and second coupling structures have a complementary shape.

3. The removable drawer system of claim 1, wherein the plate comprises at least one dovetail component, and wherein the first coupling structure comprises at least one reciprocal dovetail component.

4. The removable drawer system of claim 1, wherein the first coupling structure comprises a plurality of engagement faces oriented inward, and wherein the second coupling structure comprises a plurality of engagement faces oriented outward.

5. The removable drawer system of claim 1, wherein:
the first coupling structure comprises a first plurality of engagement faces;
the second coupling structure comprises a second plurality of engagement faces; and
the first plurality of engagement faces is configured to engage with the second plurality of engagement faces based on physical contact between the first and the second plurality of engagement faces, and wherein the physical contact restrains movement of the at least one removable drawer with respect to the plate of the rolling tool tray.

6. The removable drawer system of claim 1, wherein the at least one removable drawer and the rolling tool tray are configured to be in a coupled state when the first coupling structure is engaged with the second coupling structure and the latching mechanism is releasably coupled with a notch of the at least one removable drawer.

7. The removable drawer system of claim 1, wherein the latching mechanism is configured to secure the at least one removable drawer to the plate in a direction that is different than a plurality of directions in which the first coupling structure and the second coupling structure restrain movement of the at least one removable drawer with respect to the plate.

8. The removable drawer system of claim 1, wherein the second coupling structure and the latching mechanism are configured to secure the at least one removable drawer to the rolling tool tray across all degrees of freedom.

9. The removable drawer system of claim 1, wherein the first coupling structure and the second coupling structure are configured to restrain movement between the at least one removable drawer and the rolling tool tray in at least a first direction and a second direction, and wherein the latching mechanism is configured to restrain movement in a third direction, wherein the third direction is different than the first and second directions.

10. The removable drawer system of claim 1, wherein the at least one removable drawer is moveably housed in a slot of the toolbox via a set of drawer slides, the set of drawer slides comprising a hard stop configured to secure the at least one removable drawer in the slot.

11. The removable drawer system of claim 10, wherein the at least one removable drawer is configured to be removed from the slot by lifting the at least one removable drawer over the hard stop.

12. The removable drawer system of claim 1, wherein the lifting mechanism is a hydraulic lift, and wherein the hydraulic lift is activated in response to pressure applied to a foot pedal.

13. The removable drawer system of claim 1, further comprising a racking system configured to house the at least one removable drawer.

14. A rolling support platform comprising:
a frame;
a lifting mechanism connected to the frame;
a plurality of wheels connected to the frame to enable rolling movement; and
a plate connected to the lifting mechanism, wherein a coupling structure is defined at the plate and configured to releasably couple with a corresponding coupling structure of a removable container, the lifting mechanism being configured to adjust a vertical height of the plate.

15. The rolling support platform of claim 14, further comprising a rotating platform disposed between the plate and the lifting mechanism, wherein the rotating platform is configured to rotate the plate with respect to the frame.

16. The rolling support platform of claim 14, wherein the coupling structure comprises:
a trapezoidal planar surface defined by a pair of parallel sides and a pair of nonparallel sides, wherein a leading parallel side of the pair of parallel sides is shorter in length than a trailing parallel side of the pair of parallel sides; and
a set of angled surfaces extending from the trapezoidal planar surface, wherein each angled surface of the set of angled surfaces forms an angle with respect to the trapezoidal planar surface, the set of angled surfaces comprising:
a first angled surface extending from the trapezoidal planar surface at the leading parallel side, wherein the first angled surface extends in a first direction away from a center of the trapezoidal planar surface,
a second angled surface extending from the trapezoidal planar surface at a first nonparallel side of the pair of nonparallel sides, wherein the second angled surface extends in a second direction away from the center of the trapezoidal planar surface, and
a third angled surface extending from the trapezoidal planar surface at a second nonparallel side of the pair of nonparallel sides, wherein the third angled surface extends in a third direction away from the center of the trapezoidal planar surface.

17. The rolling support platform of claim 16, wherein the coupling structure is configured to releasably couple with the corresponding coupling structure of the removable container via insertion of the plate into the corresponding coupling structure such that the leading parallel side leads the insertion.

18. The rolling support platform of claim 16, wherein each angled surface of the set of angled surfaces extends at a same angle with respect to the trapezoidal planar surface.

19. A toolbox comprising:
a plurality of removable drawers, wherein at least one removable drawer of the plurality of removable drawers comprises a coupling structure and a notch defined at an underside of the at least one removable drawer, wherein:
the coupling structure is configured to releasably couple with a corresponding coupling structure of a support platform, and
the notch is configured to physically engage with a latching mechanism of the support platform to restrain movement of the at least one removable drawer with respect to the support platform when the at least one removable drawer is coupled with the support platform.

20. The toolbox of claim 19, wherein the coupling structure comprises a plurality of engagement faces, and wherein each engagement face of the plurality of engagement faces is oriented at an angle facing a center of the coupling structure.
